(19) United States
(12) Patent Application Publication
(10) Pub. No.: US 2023/0322620 A1
(43) Pub. Date: Oct. 12, 2023

(54) CEMENTITIOUS COMPOSITIONS COMPRISING OXIDATIVELY DEGRADED POLYSACCHARIDE AS WATER REDUCING AGENTS

(71) Applicant: SIKA TECHNOLOGY AG, Baar (CH)

(72) Inventor: Ottavio ROMBOLA, Lyndhurst, NJ (US)

(73) Assignee: SIKA TECHNOLOGY AG, Baar (CH)

(21) Appl. No.: 18/025,057

(22) PCT Filed: Dec. 7, 2021
(86) PCT No.: PCT/EP2021/084489

§ 371 Date: Mar. 7, 2023

Related U.S. Application Data
(60) Provisional application No. 17/119,255, filed on Dec. 11, 2020.

(51) Int. Cl. C04B 16/02

(52) U.S. Cl. CPC C04B 16/02; C04B 2103/302

(57) ABSTRACT

Cementitious compositions and methods for the preparation of corresponding cementitious compositions, appropriate oxidatively degraded polysaccharides and methods for producing the same, as well as the use of oxidatively degraded polysaccharides as water reducing agents in cementitious compositions, wherein the compositions include an oxidatively degraded polysaccharide as a water reducing agent to provide similar water reducing properties to cementitious composition formulated with lignosulfonates. The oxidatively degraded polysaccharides have the advantage over lignosulfonates of a lower price and a more consistent quality and are expected to be compatible with polycarboxylatether cement additives.

### TECHNICAL FIELD

The present invention relates to cementitious compositions comprising an oxidatively degraded polysaccharide as a water reducing agent, methods for the preparation thereof, appropriate oxidatively degraded polysaccharides and methods for producing the same, as well as the use of corresponding polysaccharides as water reducing agents in cementitious compositions.

### BACKGROUND OF THE INVENTION

In the construction of buildings made from concrete it is important to control the rheology of the wet concrete before and during placing. It is often a requirement that the concrete has a high flow (or slump) so that it can be easily pumped and poured. Another requirement is often that the water content of the concrete is reduced as this may lead to a higher compressive strength in the cured state. Increased fluidity (known as “slump” and slump-flow) can be realized by using large dosages of water in the concrete, but it is well known that the resulting cement-based structure exhibits insufficient compactness and will have poor final compressive strength. Furthermore, bleeding of concrete, that is separation of water and solid parts, is to be avoided.

In order to improve the flow, reduce the amount of water, and/or reduce the bleeding from wet concrete so-called superplasticizers or high range water-reducing admixtures (HRWRs) like sulfonated melamine- or naphthalene-formaldehyde polycondensates or ligninsulfonate based admixtures are frequently being used.

More recently, additives based on so called polycarboxylic acid salts, e.g. copolymers of acrylic acid with acrylic esters have been proposed for imparting high water reduction and prolonged slump life to concrete, but most of them do not lead to self-compacting concrete without bleeding, segregation or cause a too long retardation of the setting time and the strength development. An additional disadvantage is the inconstant and very low flow rate of high-flowing-high-strength concrete, containing high quantities (e.g. 500 to 700 kgs/m³) of cement and up to 20% of silica fume and fly ash, which flow rate cannot be improved by the use of conventional HRWRs.

U.S. Pat. No. 5,919,300 describes cement dispersing agents on the basis of a water-soluble N-vinyl-copolymer, which is obtained from vinylpyrrolidone, maleic acid monomers and polyglycol ester monomers. Such copolymers provide high fluidity, a low decrease in flowability with the progression of time and do not exhibit segregation over time, even with an extremely low water-to-cement ratio of said concrete.

WO 2004/094776 describes methods for cementing subterranean formations with a cement composition comprising low molecular weight starch with anionic groups. Such starch can be obtained by oxidation and subsequent sulfonation or sulfonation of an oxidized starch. However, such starches were found to provide inadequate low flow.

The conventional water reducing additives have the disadvantage of not being available from renewable resources. While this does not apply to lignosulfonates (which are a by-product from cellulose production from wood), lignosulfonates frequently have the disadvantage of a high price and an inconsistent quality. In addition, since lignosulfonates can easily be contaminated it is often necessary to incorporate higher amounts of biocide, which is undesirable from an economic as well as an ecological point of view. Finally, lignosulfonates are usually not compatible with polycarboxylate ethers (PCEs), which are frequently used as additives in concrete.

Thus, from an environmental as well as from a cost and technology point of view, it would be advantageous to have a water reducing agent for cementitious compositions which is derived from renewable resources, but which does not suffer from the same disadvantages as lignosulfonates. The present invention addresses these needs.

### BRIEF SUMMARY OF THE INVENTION

Hence, it was a general object of the present invention to provide water reducing agents which avoid at least partially the above mentioned drawbacks, i.e. to provide a water reducing agent that is derivable from renewable sources, and, much like lignosulfonates allows for the preparation of concrete having a high fluidity, a low decrease in flowability with the progression of time even with a low water-to-cement ratio of said concrete. Within the present context the terms “flow” and “slump” describe the same property of mortar or concrete. Said property being the flowability. Favourable, the water reducing agent should not suffer from the disadvantages indicated for lignosulfonates above and should be compatible with PCEs and further concrete additives.

Now, in order to implement these and still further objects of the invention, which will become more readily apparent from the following, the water reducing agent according to the invention is manifested in an oxidatively degraded polysaccharide, which is obtainable as described below. In a preferred embodiment the polysaccharide is a starch.

When the oxidatively degraded polysaccharide water reducing agent according to the present invention is used as an admixture to freshly prepared concrete of even a low water-to-cement ratio, high fluidity, low decrease in flowability with progression of time, and a comparable set time to a sample prepared with lignosulfonates as water reducing agents is obtained.

### DETAILED DESCRIPTION OF THE INVENTION

The present invention is based on extensive studies of using oxidatively degraded polysaccharides as alternative water reducing agents in mortar and concrete applications.

In a first aspect, the present invention thus relates to a cementitious composition comprising an oxidatively degraded polysaccharide as a water reducing agent, wherein the oxidatively degraded polysaccharide is obtained by subjecting a base polysaccharide to oxidative treatment, and wherein optionally, after an initial reaction time, an alkaline agent is added to the reaction mixture.

An “oxidatively degraded polysaccharide”, as this term is used in the present application, is a polysaccharide which has been subjected to oxidative treatment, in the course of which glycosidic bonds are cleaved to provide a polysaccharide molecule with a lower molecular weight than the polysaccharide which has been subjected to the oxidative treatment. In addition, the oxidatively degraded polysaccharide is modified, such that carboxylic acid or carboxylate groups are present as oxidation products of hydroxyl and aldehyde/keto groups in the starting polysaccharide molecule.

Preferably, the oxidatively degraded polysaccharide of the present invention is functionalized with carboxylic acid and/or carboxylate groups. Most preferably, the oxidatively degraded polysaccharide of the present invention is essentially free of aldehyde and/or keto groups. The presence of carboxylate groups in an oxidized starch of the present invention can be checked by FT-IT spectroscopy. For example, FT-IR can be acquired using a PerkinElmer Spectrum 100 spectrometer with ATR accessory between 4000-650 cm⁻¹. Preferably, FT-IR spectra are acquired of aqueous solutions of the oxidized starch.

A “cementitious composition” is a composition comprising cement as a functional ingredient. A cement may be any cement known to a person skilled in the art. A cement can, for example, be chosen from the group consisting of Portland cement, white cement, high alumina cement, alumina earth cement, calcium sulphoaluminate cement, blast furnace cement, puzzolane cement, magnesia cement or mixtures thereof.

The indication that “after an initial reaction time an alkaline agent is added to the reaction mixture” implies that the initial oxidation treatment is carried out in the substantial absence of an alkaline agent. Thus, the initial oxidation is e.g. carried out at a pH in the range of 1 to 5, preferably 2 to 4, more preferably 2.4 to 3.5.

As indicated above, the oxidatively degraded polysaccharides of the invention can be prepared by and are obtainable from any suitable method known to the skilled practitioner, which provides oxidatively degraded polysaccharides. Typically, the preparation of oxidatively degraded polysaccharides involves contacting the polysaccharide with an oxidation agent. Such methods are for example disclosed in EP 3,205,673.

Particularly suitable base polysaccharides for preparing the oxidatively degraded polysaccharides of the invention are starches, and in particular starches selected from corn, potato, pea and rice starch. From among these, based on price considerations, corn starch is the most preferred.

The base polysaccharide can be modified or unmodified, but is preferably either unmodified or modified, such that the starch is not crosslinked and/or charged. Preferred modifications thus include e.g. hydroxyalkylations to provide a hydroxyalkylated starch or hydroxyalkylated polysaccharide.

Suitable oxidation agents comprise any material capable of oxidizing a polysaccharide of the type disclosed herein to generate carbonyl-containing groups. The oxidizing agent may further be characterized by the ability to react with a polysaccharide and produce by-products that cannot further oxidize the polysaccharide compositions. Use of such oxidizing agents may result in an increased product stability over a long time period, for example during storage of the polysaccharide compositions. This is in contrast to oxidizing agents, for example, periodate and chlorite salts, which upon initial oxidation of polysaccharides, form by-products (e.g., iodate and hypochlorite salts) which may detrimentally further oxidize the polysaccharide composition during storage. Thus, such oxidizing agents are undesirable in the context of the present invention.

Particularly suitable oxidizing agents comprise hydrogen peroxide or contain a peroxy bond (—O—) and release hydrogen peroxide upon reaction with water. Thus, in a highly preferred embodiment, the oxidizing agent comprises hydrogen peroxide.

Alternatively, the oxidizing agent comprises a salt having X waters of crystallization wherein X is equal to or greater than 1 and wherein at least one of the waters of crystallization has been replaced with hydrogen peroxide. Such salts may be represented by the general formula Y·nH₂O·mH₂O₂ wherein Y is a salt, n is equal to or greater than zero and m is equal to or greater than 1. In an exemplary embodiment, the oxidizing agent comprises sodium percarbonate, Na₂CO₃·1.5H₂O₂. Examples of oxidizing agents which contain peroxy bonds and release hydrogen peroxide only upon reaction with water include without limitation perphosphate [(P₂O₈)⁴⁻], persulfate [(S₂O₈)²⁻], and perborate [(BO₃)⁻] salts of alkali and/or alkaline earth metals and ammonium ion.

The amount of oxidation agent on the base polysaccharide to be modified in the present invention should be such that 1 to 15 mass parts, preferably 2 to 10 mass parts, especially about 5 mass parts of oxidation agent per 100 mass parts of polysaccharide are used. E.g. if hydrogen peroxide is used as the oxidation agent, the amount of hydrogen peroxide to be added to 100 g of base starch should be in the range of 1 to 15 g, preferably in the range of 2 to 10 g, especially about 5 g (calculated as pure H₂O₂, the amount of e.g. 30% H₂O₂ is correspondingly higher). It has been found that the addition of the oxidation agent, especially of hydrogen peroxide, to the aqueous preparation of polysaccharide is best performed over a period of 1-4 hours at a temperature of not less than 50° C., preferably not less than 70° C. and not higher than the boiling point of water.

To promote the oxidative degradation, it is possible to add a catalyst to the reaction mixture. Suitable catalysts in this regard are metal salts, in particular transition metal salts such as iron salts or copper salts and more preferably salts of copper (II) or iron (II). A highly preferred catalyst in the context of the invention is copper (II) sulphate or iron (II) sulphate.

If a catalyst is added to the reaction mixture, the concentration thereof can be low such as e.g. from about 0.05 wt.-% to 1 wt.-% and preferably form 0.15 to 0.6 wt.-% (relative to the total weight of the reaction mixture used to oxidize and degrade the polysaccharide).

As is apparent from the above, the oxidatively degraded polysaccharide in the inventive cementitious composition is thus preferably a starch which has been subjected to treatment with a peroxide as the oxidation agent, preferably hydrogen peroxide, in the presence of a copper (II) salt or an iron (II) salt, preferably in the presence of copper (II) sulphate or iron (II) sulphate.

While not wishing to be bound to a particular theory, it is believed that the combination of a copper or iron catalyst and hydrogen peroxide enhances the oxidation of hydroxyl groups to carboxylic acid groups, which are able to be absorbed by cement particles thus providing water reduction properties.

The temperature, at which the oxidation and degradation of the polysaccharide is performed contributes to the properties of the oxidatively degraded polysaccharide as a water reducing agent in cementitious compositions. It was found that a temperature during the oxidative treatment of 50° C. or above but below the boiling temperature of water provides highly favourable results in this regard. Thus, in a preferred embodiment, the cementitious composition of the invention is formulated with a polysaccharide which has been subjected to oxidative treatment at a temperature of from 50° C. to 95° C., preferably 60° C. to 80° C. and even more preferably 65° C. to 75° C.

The time, during which the oxidative treatment is preformed, also has an impact on the properties of the oxidatively degraded polysaccharide. Thus, in a preferred embodiment, the oxidatively degraded polysaccharide is subjected to the oxidative treatment for 0.5 to 6 hours, preferably 1 to 4 hours and even more preferably 2 to 3 hours. This time span is the time between the first contact of the base polysaccharide and the oxidizing agent and until optionally an alkaline agent is added to this reaction mixture.

As indicated above, the oxidatively degraded polysaccharide for use in the inventive cementitious composition is obtainable by subjecting a base polysaccharide to oxidative treatment, wherein after an initial reaction time optionally an alkaline agent is added to the reaction mixture. This treatment with an alkaline agent results in a noticeable change in the performance and the set times, which becomes shorter, thus indicating that retardation is avoided. In this context, it is important that the alkaline agent is not present from the beginning but is only added after an initial oxidation/degradation of the polysaccharide. If the alkaline agent is present from the very beginning of the oxidative treatment, the effect on the set time is not observed.

The alkaline agent to be added is not subject to any relevant restrictions, except that it should be sufficiently alkaline to further alter the materials obtained after the oxidative treatment. From a cost point of view, inorganic alkaline agents such as hydroxides and carbonates are preferred. Particularly suitable alkaline agent are alkali or earth alkali metal hydroxide, wherefrom sodium hydroxide (caustic soda) is most preferred.

Where the alkaline agent has been added, the oxidation and degradation reaction is continued for a sufficient amount of time to obtain the desired properties, preferably for a time of 30 min to 2 h and more preferably for 40 min to 1 h 20 min. During this time, the reaction temperature is preferably maintained at the temperature at which the polysaccharide had previously been oxidized.

To allow for adequate access of the oxidation agents to the polysaccharide molecules, in particular when the polysaccharide is a starch, it is in addition preferred that the base polysaccharide prior to the oxidative treatment is gelled. This is typically achieved by incorporating the polysaccharide into an adequate amount of water and heating the mixture to above the gelation temperature of the polysaccharide.

After the oxidatively degraded polysaccharide has been formed, it may be possible to optimize the properties of the oxidatively degraded polysaccharide by subjecting the same to a treatment under reduced pressure, e.g. to increase the solids content of the oxidized starch. A particularly preferred treatment under reduced pressure in the context of the present invention involves a treatment at a pressure of from 50 to 100 mbar at a temperature of from 40 to 60° C., and more preferably about 50° C.

As indicated above, the oxidation treatment of the polysaccharide generates carboxylic acid groups in the oxidatively degraded polysaccharide. Thus, suitably oxidatively degraded polysaccharides of the invention can be characterized by the acid number. Advantageous oxidatively degraded polysaccharides in the context of the invention have an acid number in the range of 5 to 13 and preferably in the range of 7 to 9 mg NaOH/g.

In addition, or in alternative thereto, the oxidation treatment of the polysaccharide provides for a molecular weight of the starch which is conventionally from 2.000 to 50.000 g/mol, preferably from 4.000 to 30.000 g/mol and more preferably from 5.000 to 10.000 g/mol. These molecular weights are determined by size exclusion chromatography (SEC) against an appropriate standard. Especially SEC can be performed using a separation module Waters Alliance 2695 with a refractive index and photodiode array detector. A suitable mobile phase is 0.1M LiNO₃ in dimethylsulfoxide (DMSO), a suitable stationary phase is column PSS Gram Linear. A suitable standard is Pullulan natural polysaccharide.

According to preferred embodiments, the oxidized starches comprise or consist of oligosaccharides. An especially preferable oligosaccharide is an oligosaccharide with a degree of polymerization of 12. Thus, an oxidized starch of the present invention preferably comprises an oligosaccharide with a degree of polymerization of 12. The presence of oligosaccharides and/or the degree of polymerization thereof can be analysed by HPLC. HPLC can be performed using a separation module Waters Alliance 2695 with a refractive index and photodiode array detector. A suitable mobile phase is 0.1% NaNO₃ in water, a suitable stationary phase is column RNO Oligosaccharides.

It should be noted with regard to the above, that usually a treatment of the polysaccharides with an oxidation agent and optionally with an alkaline agent is sufficient to provide a product with suitable water reducing properties. Thus, in the context of the invention, it is preferred that the oxidatively degraded polysaccharide is not further modified, e.g. with charged groups (other than carboxy) such as sulphates or sulfonates. As indicated above, the base polysaccharide used to prepare the oxidatively degraded polysaccharides of the invention may be modified, however, if such modification is a chemical modification, it is preferred that the modification does not introduce charges into the polysaccharide. Suitable polysaccharides, which meet this requirement are e.g. hydroxyalkylated starches. In a particularly preferred embodiment, the oxidatively degraded polysaccharide contains no heteroatoms which are not found in the base starch, except for unavoidable impurities.

As noted above the inventive polysaccharides are useful as water reducing agents in admixtures for cementitious compositions. They may also be used as dispersing agents in aqueous suspensions of, for example, clays, porcelain muds, chalk, talcum, carbon black, stone powders, pigments, silicates and hydraulic binders.

Additionally, the oxidatively degraded polysaccharides of the invention are useful as water reducing agents for water-containing building- and construction materials. Thus, the inventive cementitious compositions typically comprise one or more inorganic binders selected from Portland cement, white cement, high alumina cement, alumina earth cement, calcium sulphoaluminate cement, blast furnace cement, puzzolane cement, magnesia cement or mixtures thereof. Preferred inventive cementitious compositions comprise Portland cement, white cement, high alumina cement or mixtures thereof.

Further, inventive cementitious compositions may comprise one or more additives such as sand, stones, gravel, stone powder, fly ash, slag, silica fume, burn oil shale, metakaolin, calcium carbonate, vermiculite, expanded glass, expanded clays, chamotte, light weight additives, inorganic fibers and synthetic fibers. Preferred cementitious compositions in the invention comprise sand (if the cementitious composition is a mortar) or sand and stones/gravel (if the cementitious composition is a concrete) and preferably one or more of fly ash, slag, silica fume, burnt oil shale, metakaolin or calcium carbonate.

Optionally, the inventive cementitious composition also contains components selected from the groups of surfactants, air entraining agents, antifoaming agents, set accelerating agents, set retarders and other concrete water reducing agent or high range water agents such as those described in U.S. Pat. No. 5,919,300.

In this context, the inventive oxidatively degraded polysaccharides can provide good and long lasting flowability of cementitious compositions. They may thus be used effectively in low concentrations, thereby avoiding retardation effects on setting.

The inventive cementitious composition containing the oxidatively degraded polysaccharides show high flowability and high resistance to segregation, and in additional the slump retention with progression of time, even at low water to cement-ratio, is improved.

In particular, high fluidity is provided to cement containing compositions with extremely low water-to-cement ratio. Especially, the water-to-cement weight ratio is greater than 20% and less than 60% or more preferably, greater than 25% and less than 50%.

In the inventive cementitious composition, to provide the desired effects, the oxidatively degraded polysaccharide as a water reducing agent is comprised in an amount of from 0.01 to 3 parts by weight, preferably from 0.02 to 1.5 parts by weight, especially from 0.05 to 0.5 parts per weight (in each case converted to solid content of the oxidatively degraded polysaccharide) based on 100 parts by weight of the hydraulic cement material contained in the cementitious composition.

In a preferred embodiment, the inventive oxidatively degraded polysaccharides are used in the form of a solid additive or in the form of a solution or dispersion. The inventive oxidatively degraded polysaccharides may also be added in any other conventional manner without or together with other additives. For example, they can be added to the mixing water used for the production of the cementitious composition, e.g. concrete, or to an already mixed concrete batch.

In a second aspect, the present invention relates to a method for the preparation of a cementitious composition comprising
(i) subjecting a base polysaccharide to oxidative degrading conditions,
(ii) optionally adding an alkaline agent, and
(iii) adding the thus obtained oxidatively degraded polysaccharide to a composition comprising cement.

In a third aspect, the present invention relates to an oxidatively degraded polysaccharide which is obtainable by (i) subjecting a base polysaccharide to oxidative degrading conditions and (ii) optionally adding an alkaline agent, preferably an alkali or earth alkali metal hydroxide and more preferably sodium hydroxide.

Any preferred embodiments, which have been described above for the oxidatively degraded polysaccharide as a constituent for the cementitious composition likewise apply to the oxidatively degraded polysaccharide of the third aspect of the invention. Thus, e.g. in a preferred embodiment the base polysaccharide of the oxidatively degraded polysaccharide is a starch, which is more preferably an unmodified starch and even more preferably a starch selected from corn, potato, pea and rice starch. In a further preferred embodiment, the base polysaccharide of the oxidatively degraded polysaccharide is a modified starch, preferably a hydroxyalkylated starch.

In a fourth aspect, the present invention relates to the use of an oxidatively degraded polysaccharide, preferably an oxidatively degraded polysaccharide as in the third aspect, as a water reducing agent in a cementitious composition. The use advantageously involves mixing the oxidatively degraded polysaccharide with water and cement.

In a fifth aspect, the present invention relates to an admixture for cementitious compositions comprising an oxidatively degraded polysaccharide as described above.

Especially, the admixture is an aqueous admixture comprising an oxidatively degraded polysaccharide as described above and water. Preferably, the content of the oxidatively degraded polysaccharide in the aqueous admixture is between 20 and 45 parts per weight per 100 parts per weight of the aqueous admixture.

The admixture for cementitious compositions of the present invention may additionally comprises at least one further compound selected from the list consisting of alkali metal and alkaline earth metal nitrates, alkali metal and alkaline earth metal nitrites, alkali metal and alkaline earth metal thiocyanates, a-hydroxycarboxylic acids, alkali metal and alkaline earth metal halides, glycerol and glycerol derivatives, glycols and/glycol derivatives, aluminum salts, aminoalcohols, calcium silicate hydrates, and polycarboxylate ethers. Optionally, co-solvents, thickeners and/or biocides may be additionally present.

Especially preferred further compounds to be present in an admixture of the present invention are gluconic acids and its salts, especially sodium gluconate, triethanolamine (TEA), triisopropanolamine (TIPA), hydroxyethylbis(isopropanol)amine (EDIPA), bis(hydroxyethyl)isopropanolamine (DEIPA), methyldiethanolamine (MDEA), calcium nitrate, and/or polycarboxylate ethers.

For the above second, fourth, and fifth aspects, any preferred embodiments which have been described above for the first aspect likewise apply. Polycarboxylate ethers are copolymers with a comb-like structure comprising
a) a molar parts of a structural unit S1 of formula I

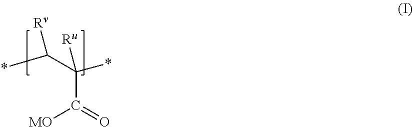

b) b molar parts of a structural unit S2 of formula II

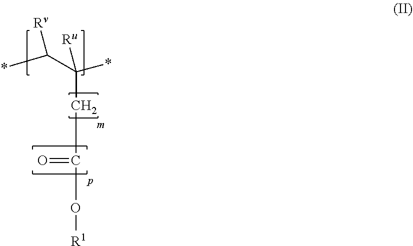

c) c molar parts of a structural unit S3 of formula III

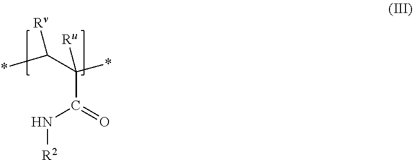

d) d molar parts of a structural unit S4 of formula IV

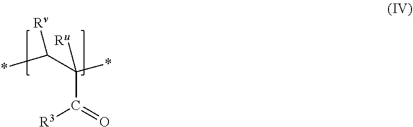

wherein
each M independently from each other represents H⁺, an alkali metal ion, an alkaline earth metal ion, a di- or trivalent metal ion, an ammonium ion or an organic ammonium group,
each R^{u} independently from each other represents hydrogen or a methyl group,
each R^{v} independently from each other represents hydrogen or COOM,
m=0, 1, 2 or 3,
p=0 or1,
each R¹ and each R² independently from each other represents C₁- to C₂₀-alkyl, -cycloalkyl, -alkylaryl or for -[AO]ₙ—R⁴,
   whereby A=C₂- to C₄-alkylene, R⁴ represents H, C₁- to C₂₀-alkyl, -cyclohexyl or -alkylaryl,
   and n=2-350, preferably n=30-125,
each R³ independently of the others represents NH₂, —NR⁵R⁶, —OR⁷NR⁸R⁹,
   wherein R⁵ and R⁶ independently from each other stand are C₁- to C₂₀-alkyl, -cycloalkyl
      alkylaryl or -aryl,
      or for a hydroxyalkyl- or acetoxyethyl- (CH₃—COO—CH₂—CH₂—) or hydroxyisopropyl- (HO—CH(CH₃)—CH₂—) or acetoxyisopropyl group (CH₃—COO—CH(CH₃)—CH₂—);
   or R⁵ and R⁶ together form a ring of which the nitrogen is part, to form a morpholine or imidazoline ring,
   R⁷ is a C₂-C₄-alkylene group,
   each R⁸ and R⁹ independently from each other represent C₁- to C₂₀-alkyl, -cycloalkyl, -alkylaryl,
      aryl or a hydroxyalkyl group,
and whereby a, b, c and d stand for the molar parts of the structural units S1, S2, S3 and S4, with a/b/c/d/=(0.1-0.9)/(0.05-0.9)/(0-0.8)/(0.0-0.8), in particular a/b/c/d=(0.3-0.9)/(0.05-0.7)/(0-0.3)/(0.0-0.4)
and with the provision that a+b+c+d=1.

Advantageously, the molar parts of the structural units S1, S2, S3 and S4 are a/b/c/d=(0.3-0.9)/(0.05-0.7)/0/0.

According to particular advantageous embodiments, the ratio of a/b is between 0.5/1 and 15/1, preferably between 1/1 and 11/1, more preferably between 1.5/1 and 9/1, most preferably between 3/1 and 8/1, especially between 6/1 and 7/1.

According to a particularly advantageous embodiment, R^{u} and R^{v} each represent a hydrogen or a methyl group, m=1, p=0 and R¹ represents -[AO]ₙ—R⁴ where A represents a C₂-alkylene, n=50-115, and R⁴ being selected from H or CH₃.

Methods for producing such PCE-type copolymers are known in the art. Two main methods are industrially used for synthesizing such PCE-type copolymers. The first method is radical polymerisation of ethylenically unsaturated monomers. Side chains of the resulting PCE-type copolymers are already attached to monomer units. PCE-type copolymers with desired structures and properties are obtained by specific selection and ratio of the monomers. Such radical polymerisation as well as resulting PCE-type copolymers are described, for example, in WO2012/084954.

In a second method known as polymer analogous reaction, a polycarboxylic acid backbone is synthesized in a first step. Subsequently, side chains are attached to the polycarboxylic acid backbone, for example by esterification, amidation or etherisation reactions with alcohols, amines and the like. Such polymer analogous reactions as well as resulting PCE-type copolymers are described, for example, in EP1138697 and WO2005/090416.

According to particularly suitable embodiments of the present invention, an admixture of the present invention comprises or consists of (in each case relative to the total weight of the admixture):
a) 20-45 w % of oxidatively degraded polysaccharide, preferably oxidatively degraded starch,
b) 2-20, preferably 4-10 w % of alkali metal or alkaline earth metal nitrate,
c) 1-10 w % of at least one polycarboxylate ether, and
d) the balance water.

The following examples illustrate in more detail the present invention and describe the use and the performance of inventive copolymers more clearly.

However, it must be noted that these examples are given for illustrative purposes only and are not supposed to limit the invention, as defined by the claims.

### EXAMPLES

### Example 1 Preparation and Performance of Starch Oxidized without Alkaline Treatment

Pre-gelled corn starch D17F from Grain Processing Corp was used.

100 g of the D17F starch was dissolved in 122 g of water. The mixture was heated to 70° C. At this temperature 0.09 g of CuSO4·5 H₂O were added and then 19.7 g of a 30% (w/w) solution of hydrogen peroxide in water were slowly added over the course of 1 hour. After complete addition the temperature was maintained at 70° C. and the pressure was reduced. The reaction was allowed to proceed for another hour.

An aqueous solution of oxidized starch was thus obtained (starch 1) with a solids content of appr. 44% (w/w), a pH of 2.5, a viscosity of 2000 mPas at 23° C., and an acid number of 45 mg KOH/g.

The FT-IR spectrum of the oxidized starch 1 showed a strong peak at 1726 cm⁻¹. The molecular weight as measured by SEC was Mw=20000 g/mol. The presence of oligosaccharides and especially species with a degree of polymerization of 12 was revealed by HPLC.

The performance of starch 1 was tested in mortar samples. Mortars were prepared from 1088 g cement (Holcim), 270 g limestone filler, and a total of 3339 g sand (fractions between 0-8 mm) at a water/cement ratio of 0.445.

The respective test samples were prepared as follows:

The sand, limestone, water and the respective additive were mixed for 1 min. At 50 sec to 1 min the cement was added, and the mixture was further mixed for 3 min. Subsequently, the flow and set times were measured as follows:

The slump (in the present context identical to flow) was measured according to standard ASTM C1810.

The following table 1 shows the results.

TABLE 1

| | Amount of | | Slump [mm] after | | | | |
|---|---|---|---|---|---|---|---|
| | additive** | W/C | 0 | 20 | 40 | 60 | 80 |
| Sample | [g] | ratio | min | min | min | min | min |
| Lignosulfonate* | 1.96 | 0.445 | 215 | 177 | 177 | 175 | 162 |
| Starch 1 | 1.96 | 0.445 | 207 | 185 | 177 | 177 | 162 |

*not according to the invention
**calculated for pure additive at 100% solids content

It can be seen from the above results that the oxidized starch of the present invention performs similar as a lignosulfonate in terms of plastification of a mortar.

The performance of starch 1 was further tested in concrete.

Concrete samples were prepared from 1318 g of cement (Permanente), 32.8 kg of sand, and 45.3 kg of gravel at a water/cement ratio of 0.602. The respective test samples were prepared as follows:

The sand, stone and 90% of the water were mixed for 1 min. Then the cement was added, and the mixture was further mixed for 1 min, before the rest of the water was added and the mixture was further mixed for 3 min. Finally, the respective additive was added, and the mixture was further mixed for 3 min.

The slump (in the present context identical to flow) was measured according to standard ASTM C143. The set time was measured according to ASTM C1702. In addition, the compressive strength was measured according to standard ASTM C109.

The following table 2 shows an overview of the results.

TABLE 2

| | Amount of | | Slump [mm] after | | | | Set time | Compressive |
|---|---|---|---|---|---|---|---|---|
| | additive | W/C | 0 | 20 | 40 | 60 | start/end | strength [psi] |
| Sample | [ml]** | ratio | min | min | min | min | [min] | after 28 d |
| Lignosulfonate* | 68 | 0.602 | 152 | 95 | 83 | 76 | 232/471 | 6243 |
| Starch 1 | 68 | 0.602 | 152 | 95 | 89 | 76 | 199/502 | 6327 |

*not according to the invention
**pure additive at 100% solids content

The above results show that an oxidized starch according to the present invention shows a comparable performance in concrete as a conventional lignosulfonate.

### Example 2 Comparison Against a Starch Produced According to Prior Art

To compare the performance of a starch according to the present invention and of a starch according to WO 2004/094776, the example described on page 11 (last paragraph) to page 12 (first two paragraphs and table 6) of WO 2004/094776 were repeated. Samples were taken before the addition of sulphite (Starch 2) and after completion of the reaction (Starch 3). A sample of the starting material, starch “D17F”, was also measured.

Mortar samples were prepared as described in Example 1. Subsequently, the flow was measured as described in example 1.

The test results of the samples are provided in the following table 3.

TABLE 3

| | Amount of | | Slump [mm] after | | | | |
|---|---|---|---|---|---|---|---|
| | additive | W/C | 0 | 20 | 40 | 60 | 80 |
| Sample | [g]** | ratio | min | min | min | min | min |
| Starch 1 | 11.97 | 0.445 | 205 | 182 | 180 | 175 | 160 |
| Starch D17F | 11.97 | 0.445 | 180 | 176 | 172 | 160 | 160 |
| Starch 2* | 11.97 | 0.445 | 171 | 162 | 160 | 160 | 155 |
| Starch 3* | 11.97 | 0.445 | 170 | 170 | 162 | 162 | 155 |

*not according to the invention
**as aqueous dispersion (10% solids content)

It can be seen from the above results that an oxidized starch of the present invention performs better as compared to oxidized, sulphated starches of the prior art.

### Example 3 Preparation and Performance of Starch Oxidized with Alkaline Treatment

Corn starch B20F from Grain Processing Corp and Corn starch from Roquette were used as starting materials.

100 g of the respective starch in 120 ml of water were first subjected to gelatinization treatment by heating an aqueous mixture of the starch to 95° C. Subsequently, the temperature was set to 70° C. At this temperature 0.09 g of CuSO4·5 H₂O were added and then 19.7 g of a 30% (w/w) solution of hydrogen peroxide in water were slowly added over the course of 1 hour. The thus obtained mixtures were maintained at these conditions for 2 h.

The starches obtained were investigated by size-exclusion chromatography (SEC) after the oxidation step. It was found that the majority of the starch in solution had a molecular weight of about 20000. In the FT-IR, a strong band at 1726 cm⁻¹ (indicative for the carboxylic acid group) was detected.

Thus, it was confirmed that the starch is oxidized and degraded.

In this manner starch samples 4 and 5 were prepared from B20F (starch 4) and Roquette corn starch (starch 5). These samples are not according to the present invention

For the preparation of starch sample 6 (B20F) and 7 (Roquette corn starch), the reaction mixture after oxidation was treated with 50% aqueous NaOH solution (18.5 g pure NaOH per 100 g of starch) for an additional 1 h.

An investigation of the starches after the treatment with caustic soda by size-exclusion chromatography indicated a molecular weight of less than 8000. In addition, the UV-Vis spectra show absorptions at 265 nm and 240 nm, which can be attributed to double bonds. In the FT-IR spectra a band at 1580 cm⁻¹ (indicative for carboxylate group) was observed.

The starches thus obtained were tested in mortars as described in example 1 above.

The test results of the samples in comparison to a lignosulfonate reference sample are provided in the following table 4.

TABLE 4

| | Amount of | | Slump [mm] after | | | | | Set time |
|---|---|---|---|---|---|---|---|---|
| | additive | W/C | 0 | 20 | 40 | 60 | 80 | start/end |
| Sample | [g]** | ratio | min | min | min | min | min | [min] |
| Lignosulfonate* | 6.79 | 0.445 | 202 | 192 | 185 | 280 | 167 | 447/704 |
| Starch 4* | 13.8 | 0.445 | 207 | 190 | 182 | 177 | 162 | 995/1461 |
| Starch 6 | 11.97 | 0.445 | 205 | 182 | 180 | 175 | 160 | 579/874 |
| Starch 5* | 14.11 | 0.445 | 207 | 192 | 182 | 177 | 168 | 1176/1577 |
| Starch 7 | 12.98 | 0.445 | 200 | 182 | 170 | 162 | 160 | 572/856 |

*not according to the invention
**calculated for pure additive at 100% solids content

As is apparent from the above, the performance of the water reducing agents based on oxidatively degraded starches in mortar in terms of water reduction and slump retention are about comparable to the lignosulfonate reference. In starches 4 and 5, which had not been treated with caustic soda, the set times were considerably longer than for the lignosulfonate reference. Starch samples additionally treated with caustic soda (starches 6 and 7) exhibited similar water reduction and slump retention as the starches 4 and 5, but in addition set times which are comparable to the lignosulfonate reference sample.

The starches thus obtained were tested in concrete as described in example 1 above.

The test results of the samples in comparison to a lignosulfonate reference sample are provided in the following table 5

TABLE 5

| | Amount of | | Slump [mm] after | | | | Set time | Compressive |
|---|---|---|---|---|---|---|---|---|
| | additive | W/C | 0 | 20 | 40 | 60 | start/end | strength [psi] |
| Sample | [g]** | ratio | min | min | min | min | [min] | after 7 h |
| Lignosulfonate* | 29 | 0.647 | 7 | 4.75 | 4 | 3.5 | 330/500 | 1275/3167 |
| Starch 4* | 29 | 0.647 | 7 | 5 | 4 | 3.5 | 378/520 | 1220/3273 |
| Starch 6 | 25 | 0.647 | 7.25 | 4.5 | 4 | 3.75 | 354/488 | 1167/3093 |
| Starch 5* | 29 | 0.647 | 7 | 5.5 | 4.25 | 3.75 | 351/502 | 1197/3097 |
| Starch 7 | 27 | 0.647 | 6.75 | 4.5 | 4 | 3 | 33/475 | 1173/2990 |

*not according to the invention
**calculated for pure additive at 100% solids content

The results in the above table show that in concrete the oxidatively degraded starches provide comparable performance to the lignosulfonate water reducing agent in terms of the compressive strength and set characteristics.

### Example 4 Admixture Comprising Oxidatively Degraded Starch and Accelerator

Starch 1 as prepared in example 1 was used in an admixture with calcium nitrate. The admixture used in this example consisted of 40 w-% of starch 1, 45 w-% of calcium nitrate, and 15 w-% of water. This admixture was tested in a mortar as described in example 1, the only difference being that instead of cement from Holcim, a cement from Permanente was used.

TABLE 6

| | Amount of | | Slump [mm] after | | | | | Set time |
|---|---|---|---|---|---|---|---|---|
| | additive** | W/C | 0 | 20 | 40 | 60 | 80 | start/end |
| Sample | [g] | ratio | min | min | min | min | min | [min] |
| Lignosulfonate* | 1.96 | 0.473 | 200 | 187 | 182 | 175 | 172 | 283/485 |
| Admixture | 1.96 | 0.473 | 192 | 185 | 180 | 175 | 172 | 282/466 |

*not according to the invention
**calculated for pure additive at 100% solids content

The results in table 6 show that it is possible to combine an oxidatively degraded starch of the present invention with an accelerator. The plasticizing properties of this admixture are still comparable to a pure lignosulfonate plasticizer. The hardening of a cementitious composition comprising this admixture is also very similar to the hardening of a mortar comprising pure lignosulfonate.

### Example 5 Preparation and Performance of Starch Oxidized with Iron Catalyst

100 g of pre-gelled corn starch D17F from Grain Processing Corp were added to 122 ml of water at a temperature of 50° C. After complete addition of the starch, 0.1 g of iron(II) sulphate heptahydrate (0.36 mmol or iron(II) sulphate) were added while the temperature was maintained at 50° C. Subsequently, 19.7 g of a 30% (w/w) solution of hydrogen peroxide in water were slowly added over the course of 2 hours. The temperature was allowed to raise to 70° C. The thus obtained mixture was maintained at these conditions for 1 h and then cooled to room temperature to obtain a yellow, slightly viscous liquid with a solids content of about 37%.

The starch obtained (starch 8) was investigated by size-exclusion chromatography (SEC) after the oxidation step. It was found that the majority of the starch in solution had a molecular weight of about 10000 g/mol.

For the preparation of starch sample 9, the reaction mixture after oxidation was treated with 50% aqueous NaOH solution (18.5 g pure NaOH per 100 g of starch) for an additional 1 h.

To test starch samples 1 (as prepared in example 1), 8 and 9, admixtures were prepared from the respective starch samples. The admixtures contained 40 w-% of starch 1, 8 or 9 respectively, 45 w-% of calcium nitrate, and 15 w-% of water.

The performance of admixtures was tested in mortar samples. Mortars were prepared from 1088 g cement (Mojave), 270 g limestone filler, and a total of 3339 g sand (fractions between 0-8 mm) at a water/cement ratio of 0.535. The respective test samples were prepared as follows:

The sand, limestone, water and the respective additive were mixed for 1 min. At 50 sec to 1 min the cement was added, and the mixture was further mixed for 3 min.

The slump (in the present context identical to flow) was measured according to standard ASTM C143. The set time was measured according to ASTM C1702. In addition, the compressive strength was measured according to standard ASTM C109.

The following table 7 shows an overview of the results.

TABLE 7

| Sample with | Amount of | Slump [mm] after | | | | Set time | Compressive |
|---|---|---|---|---|---|---|---|
| admxiture | additive | 0 | 20 | 60 | 100 | start/end | strength [psi] |
| having | [g]** | min | min | min | min | [min] | after 7 d |
| Starch 1 | 1.96 | 79 | 71 | 61 | 38 | 421/660 | 4460 |
| Starch 8 | 1.96 | 69 | 71 | 58 | 36 | 438/680 | 4430 |
| Starch 9 | 1.96 | 74 | 64 | 58 | 38 | 404/629 | 4390 |

*From example 1
**calculated for pure additive at 100% solids content

1. A cementitious composition comprising an oxidatively degraded polysaccharide as a water reducing agent, wherein the oxidatively degraded polysaccharide is obtained by subjecting a base polysaccharide to oxidative treatment, and optionally after an initial reaction time an alkaline agent is added to the reaction mixture.

2. The cementitious composition according to claim 1, wherein the oxidative treatment is performed with hydrogen peroxide as the oxidation agent in the presence of a copper (II) salt or an iron (II) salt.

3. The cementitious composition according to claim 1, wherein the oxidative treatment at a temperature of from 50° C. to 95° C.

4. The cementitious composition according to claim 1, wherein, where an alkaline agent is added to the reaction mixture, the oxidative treatment is for 0.5 to 6 hours before an alkaline agent is added.

5. The cementitious composition according to claim 1, wherein the amount of oxidation agent is between 1 to 15 mass parts of polysaccharide.

6. The cementitious composition according to claim 1, wherein the base polysaccharide prior to the oxidative treatment is gelled.

7. The cementitious composition according to claim 1, wherein, where an alkaline agent is added, the alkaline agent is selected from an alkali or earth alkali metal hydroxide.

8. The cementitious composition according to claim 1, wherein the oxidatively degraded polysaccharide as a water reducing agent is comprised in an amount of from 0.01 to 3 parts by weight (converted to solid content of the oxidatively degraded polysaccharide) based on 100 parts by weight of the hydraulic cement material contained in the cementitious composition.

9. A method for the preparation of a cementitious composition comprising
(i) subjecting a base polysaccharide to oxidative degrading conditions,
(ii) optionally adding an alkaline agent after an initial reaction time, and
(iii) adding the thus obtained oxidatively degraded polysaccharide to a composition comprising cement.

10. An oxidatively degraded polysaccharide obtainable by (i) subjecting a base polysaccharide to oxidative degrading conditions and optionally (ii) adding an alkaline agent and continuing the oxidative degradation.

11. The oxidatively degraded polysaccharide according to claim 10, wherein the base polysaccharide is an unmodified starch.

12. The oxidatively degraded polysaccharide according to claim 10, wherein the base polysaccharide is a modified starch.

13. A method of manufacturing a cementitious composition, comprising adding to a mixture the oxidatively degraded polysaccharide according to claim 10 as a water reducing agent.

14. The method according to claim 13, comprising mixing the oxidatively degraded polysaccharide with water and cement.

15. An admixture for cementitious compositions comprising an oxidatively degraded polysaccharide according to claim 10.

16. The admixture for cementitious compositions according to claim 15, wherein it comprises at least one further compound selected from the list consisting of alkali metal and alkaline earth metal nitrates, alkali metal and alkaline earth metal nitrites, alkali metal and alkaline earth metal thiocyanates, a-hydroxycarboxylic acids, alkali metal and alkaline earth metal halides, glycerol and glycerol derivatives, glycols and/glycol derivatives, aluminum salts, aminoalcohols, calcium silicate hydrates, and polycarboxylate ethers.
